(19) United States
(12) Patent Application Publication
(10) Pub. No.: US 2010/0127031 A1
(43) Pub. Date: May 27, 2010

(54) COORDINATED ADJUSTABLE TRUNK RACK FOR CARRYING BICYCLES

(75) Inventors: Chris Sautter, Portland, OR (US); Mike Kemery, Seattle, WA (US); Zac Elder, Portland, OR (US); Richard Jeli, Milwaukie, OR (US); Kevin E. Lesley, Beaverton, OR (US)

Correspondence Address: KOLISCH HARTWELL, P.C., 200 PACIFIC BUILDING, 520 SW YAMHILL STREET, PORTLAND, OR, 97204, US

(73) Assignee: YAKIMA PRODUCTS, INC., Beaverton, OR (US)

(21) Appl. No.: 12/493,114

(22) Filed: Jun. 26, 2009

Related U.S. Application Data
(60) Provisional application No. 61/133,258, filed on Jun. 26, 2008.

(51) Int. Cl. B60R 9/10

(52) U.S. Cl. 224/500; 224/505

(57) ABSTRACT

A carrier for a bicycle includes first and second frame elements configured for coupling to a vehicle. The elements are configured such that one can slide past the other to allow adjustment for various vehicle sizes and shapes. A slide restriction mechanism allows reversible fixation of a relative positioning of the first and second frame elements. In some embodiments, the first and second frame elements are arcuate in shape, such that the overall bicycle carrier is roughly semicircular in profile view when configured for attachment to a vehicle.

### CROSS-REFERENCE TO RELATED APPLICATIONS

This application claims priority under 35 U.S.C. §119(e) to U.S. Provisional Patent Application Ser. No. 61/133,258 filed on Jun. 26, 2008 and entitled “Coordinated Adjustable Trunk Rack for Carrying Bicycles.” The complete disclosure of the above-identified patent application is hereby incorporated by reference for all purposes.

This application incorporates by reference in their entirety for all purposes the following U.S. patents and patent application publications: U.S. Pat. No. 4,109,839; U.S. Pat. No. 4,182,467; U.S. Pat. No. 4,394,948; U.S. Pat. No. 5,056,700; U.S. Pat. No. 5,495,970; U.S. Pat. No. 5,645,202; U.S. Pat. No. 6,345,748; U.S. Pat. No. 6,502,729; U.S. Pat. No. 6,840,418; U.S. Pat. No. 7,404,504; 2002/0117524; 2006/0060623; 2006/0138186.

### FIELD OF THE INVENTION

This disclosure relates to racks for carrying bicycles, particularly racks configured for mounting on the rear of a vehicle, such as on or near a vehicle's trunk or rear hatch.

### BACKGROUND

There are many types of racks for securing bicycles to a variety of vehicles. For example, there are racks for carrying bicycles on top or at the rear of a car, in the bed of a pick-up, at the front of a bus, etc. Many bicycle racks for a vehicle are relatively large and may lack adjustability for a wide variety of vehicle shapes and sizes. In other cases, the racks, even if adjustable, may be cumbersome and difficult to handle during the adjustment process. Thus, there is a need for highly adjustable bicycle racks or carriers that are easy to adjust over a wide range of vehicle-accommodating sizes.

### BRIEF SUMMARY

A bicycle carrier is configured to be removably mounted on a trunk or rear portion, for example a rear hatch, of a vehicle. The bicycle carrier may include first and second frame elements configured to rest on a vehicle, where the second frame element has a body configured to rest on a vehicle and to allow the first frame element to slide relative to the body of second frame element. The bicycle carrier may include measurement marks on at least one of the frame elements, allowing a user of the carrier to note the relative position of the frame elements relative to each other.

The bicycle carrier also may include a slide restriction mechanism configured to inhibit sliding of the first frame element within the body of the second frame element. The slide restriction mechanism may include a clamping member and a tightening mechanism, where the tightening mechanism may actuate the clamping mechanism to press against a portion of one of the frame elements. The carrier may also include a shoulder component mounted to one or both of the frame elements, and an arm coupled to the shoulder in a way that allows the arm to move through a range of angles relative to the frame elements.

### BRIEF DESCRIPTION OF THE DRAWINGS

FIG. 1 is a perspective view of an embodiment of a bicycle carrier configured for mounting on the rear of a vehicle, according to the present disclosure.

FIG. 1A is a rear view of the bicycle carrier and vehicle shown in FIG. 1

FIG. 2 is a side view of the bicycle carrier embodiment shown in FIG. 1, according to the present disclosure.

FIG. 3 is a partial perspective view of the bicycle carrier embodiment shown in FIG. 1, according to the present disclosure.

FIG. 4 is a partial perspective view of the bicycle carrier embodiment shown in FIG. 1, according to the present disclosure.

FIG. 5 is a partial cross-sectional view focusing on a clamping mechanism used in the rack shown in FIG. 1.

FIG. 6 is a partial cross-sectional view from another clamping mechanism used in the rack shown in FIG. 1.

FIGS. 7-10 are perspective views of alternative rack embodiments.

FIG. 11 is a perspective view of a security strap for linking a rack or cargo item to a locked vehicle.

FIG. 12 is a cross-sectional view of the security strap shown in FIG. 11.

FIGS. 13 and 14 are perspective views showing the security strap of FIG. 11 in use.

### DETAILED DESCRIPTION

Bicycle carriers, as described below, are configured to allow a wide range of positions of the carrier's legs, allowing fit of the carrier to many vehicle sizes and styles. For example, the carrier may as easily be fit to a vehicle having a trunk, as to a vehicle having a hatch back or even a substantially flat back (such as a minivan). To allow the carrier to fit on many types and sizes of vehicles, the carrier may, for example, have an arcuate profile, arising from its use of legs whose shapes define a substantially semicircular path. The legs may be configured to slide past each other, either at a defined spot (for example, if the legs slide past each other at an intersection point) or over a defined path (for example, if one leg slides within the housing of another; i.e. the legs “telescope”).

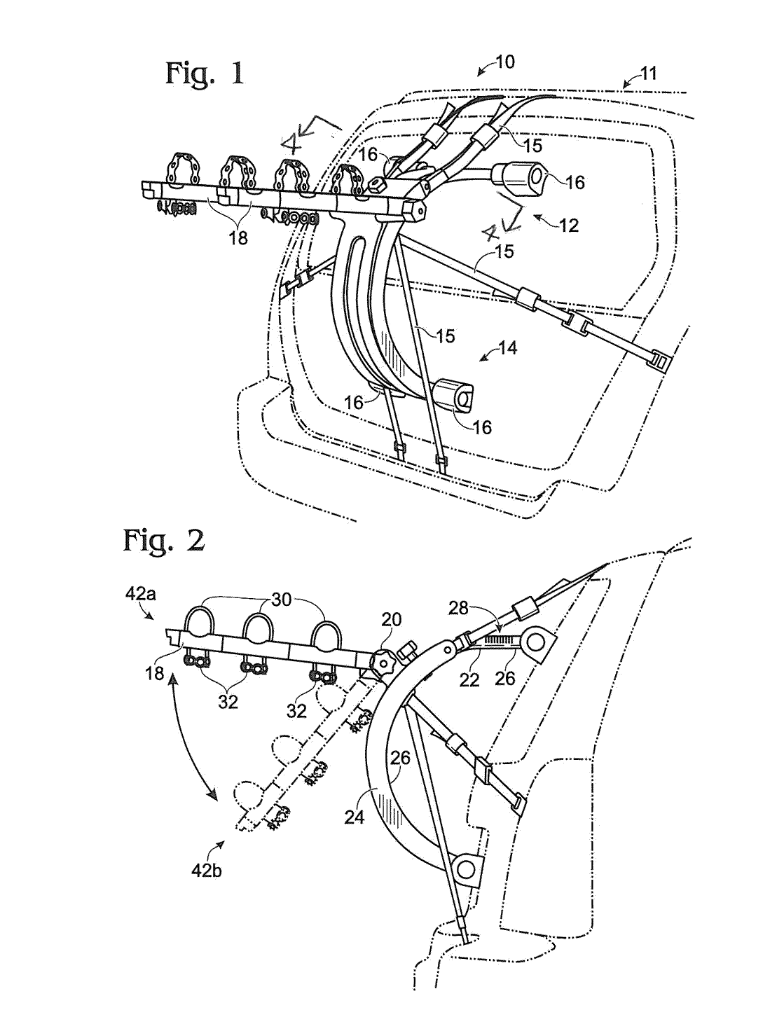

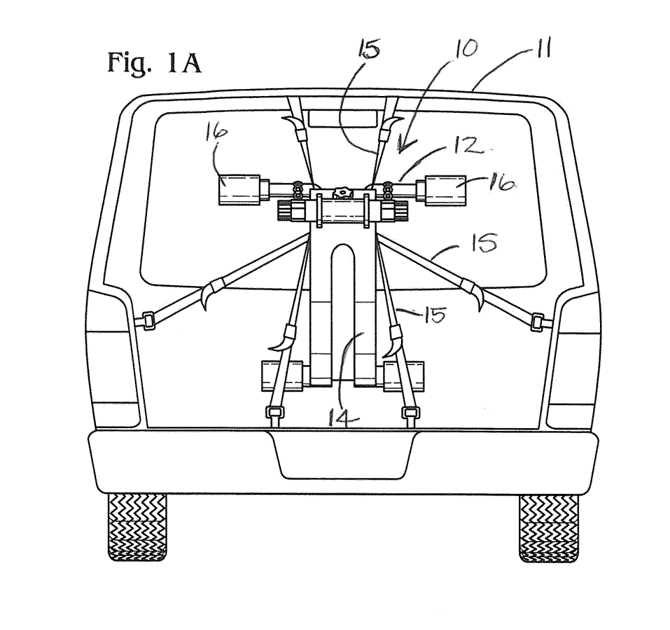

FIGS. 1, 1A, and 2 show perspective, rear and side views, respectively, of one embodiment of a bicycle carrier 10 configured for and mounted to the rear of a vehicle 11. The bicycle carrier 10 may contact the vehicle 11 by means of the carrier's first frame element 12 and second frame element 14. The frame elements may also be described as the “legs” of the carrier. Frame elements 12, 14 of the carrier may include frame feet 16, which may function to protect the surface of the vehicle from abrasion that could be caused by the frame elements 12, 14 of the bicycle carrier 10. The carrier may be stabilized in position on the vehicle 11 by one or more straps 15.

Bicycle carrier 10 may include one or more arms 18 configured to support one or more bicycles (not shown) on the vehicle. Each of arms 18 may be coupled to the first or second frame element (or both, depending on the design of the carrier) at shoulder 20. Each shoulder 20 may be configured to allow its attached arm 18 to be reversibly fixed at a variety of angular positions relative to other parts of the bicycle carrier. For example, each arm 18 may be set to an angular position 42a, or it may be set to an angular position 42b, or it may have any other appropriate angular position with respect to other elements of the bicycle carrier. Each of arms 18 may be set to the same angular position, or they may be set to different angular positions, as required by the needs of a user.

As seen in FIGS. 1 and 2, first frame element 12 may have a first body 22 and the second frame element 14 may have a second body 24. Each of the first and second bodies 22, 24 may be a tubular member 26 (with “tubular” meaning that the element has a hollow opening along a substantial portion of its length). Alternatively, one or the other, or both, of the first and second bodies may be substantially or completely solid, so long as the complete bicycle carrier 10 maintains its ability, as described below, to be reversibly adjustably fitted to a vehicle 11.

One or the other, or both, of first and second frame elements 12, 14 may include measurement markings 28 that may be used for accurately positioning frame elements 12, 14 relative to each other. The measurement markings may be printed on the element having the marks, or they may be engraved on a surface of the element, or otherwise appropriately be fixed to the element. In the illustrated embodiment, frame elements 12, 14 are in a sliding relationship (described below), and the measurement markings are arranged so that they indicate the relative sliding position of the first and second frame elements 12, 14. Allowing repeatable accurate positioning of the elements when the carrier is removed from and placed onto a vehicle makes for more efficient use of the carrier.

As mentioned above, the bicycle carrier may include one or more arms 18 configured to carry one or more bicycles (not shown). FIGS. 2 and 3 show that each arm may be configured to carry bicycles in bicycle restraint devices 30 in association with anti-sway or stabilizer elements 32. Bicycle restraint devices 30 and anti-sway elements 32 may keep a bicycle from experiencing excessive movement when it is carried in a trough or saddle 34 on an arm 18, or on another portion of the arm, and the carrying vehicle is in motion. Typical restraint and anti-sway devices, and their function, are described in U.S. Pat. No. 6,286,738, the disclosure of which is incorporated herein by reference in its entirety.

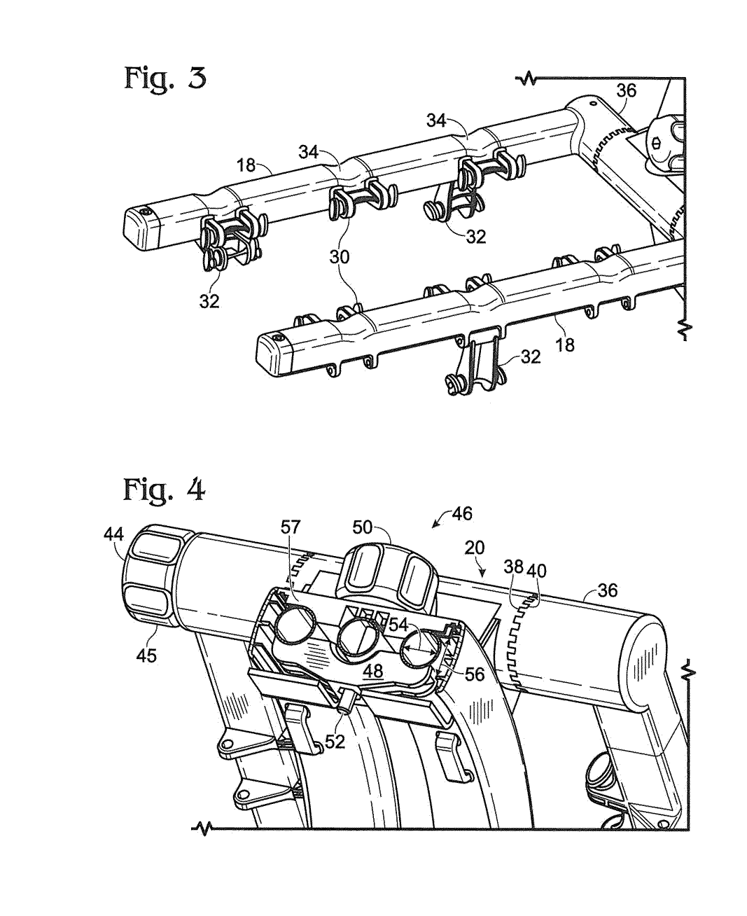

FIGS. 3 and 4 show partial perspective views of the bicycle carrier embodiment shown in FIG. 1. As seen in the Figures, proximal end 36 of arm 18 may couple to shoulder 20 of the carrier. Shoulder 20 and proximal end 36 of arm 18 may meet at castellated surfaces 38 and 40 of the shoulder and arm, respectively. The castellated surfaces may provide an interlocking or meshing interaction between the shoulder and arm such that the arm can be held at discrete angular positions 42a, 42b (shown in FIG. 2) relative to the shoulder. Although each surface is depicted as having a square-wave profile, any appropriate profile that allows discreet positioning and locking of the arm and shoulder is possible. For example, the surfaces could have a sine-wave profile, or a more complex profile. In addition, the profile of the castellated surface may be designed with any desired level of detail. For example, the surface may include relatively few “notches” with which to fix an angular position, providing fewer potential angular positions, or the surface may include a large number of “notches,” providing much finer angular positioning of the arms.

Typically, the castellated surfaces 38, 40 of the shoulder and arm can be reversibly tightened into and out of a close meshing relationship. To provide reversible tightening of the interacting surfaces, the carrier may be equipped with arm fixation mechanism 44. The arm fixation mechanism may be configured as shown in FIG. 4. Mechanism 44 may include tightening knob 45 coupled to a proximal end of an extended rod or bolt (not shown) which traverses the shoulder region 20 of the carrier. The proximal end of the bolt may thread through a proximal end of a first arm while the distal end of the bolt may be threaded into the proximal end of a second arm. In this way, when the bolt is screwed into the proximal end of the second arm, the bolt may “squeeze” the entire shoulder-and-arm assembly together, securing the interaction of the castellated surfaces and substantially fixing the relative positions of arms 18 and shoulders 20. Alternatively, the bolt may be screwed out of the proximal end of the second arm “relaxing” the fit of the entire shoulder-and-arm assembly and allowing freer relative movement of the arms and shoulders. An internal spring device (not shown) may be used to bias complimenting teeth to disengage when the fixation mechanism is loosened.

In addition to including an arm fixation mechanism 44 for fixing the angular position of arms 18 relative to shoulder 20 of the frame, bicycle carrier 10 may include a slide restriction mechanism 46 for reversibly fixing the relative position of frame elements 12, 14 to accommodate a particular trunk or hatch profile of a vehicle. The slide restriction mechanism shown in FIG. 4 (cross-sectional view through rack in FIG. 1) includes clamping member 48 that can be reversibly held against one or both of the frame elements upon manipulation of tightening knob 50. The tightening knob, when rotated, may operate on a tightening screw or bolt 52 that threads into a portion of clamping member 48.

Turning tightening knob 50 and, thus, bolt 52 in the appropriate direction may cause clamping member 48 to “squeeze” one of the first and second frame elements against the other. In this way, the slide restriction mechanism may restrict the sliding interaction between the frame elements. In the illustrated embodiment, for example, the first frame element may have a tubular element body having an outer element diameter 54, while the second frame element may have a tubular element body having an inner element diameter 56. The inner element diameter 56 may be defined by the spacing between the clamping member 48 and an inner wall 57 of the second frame element.

In a configuration where the first and second elements are able to relatively freely slide past each other, diameter or gap 56 is greater than diameter 54. To restrict sliding of the frame elements, tightening knob 50 and bolt 52 are turned in a way that causes clamping member 48 to move toward inner wall 57 of the second frame element. As gap 56 approaches the value for diameter 54, sliding of the first and second frame elements 12, 14 will become progressively more difficult until eventually the elements are frictionally fixed. At this point (where a sufficient amount of tightening is achieved to maintain a desired spatial relationship between the frame elements when they are carrying bicycles on a vehicle) the frame elements may be described as “fixed” or “locked” into position.

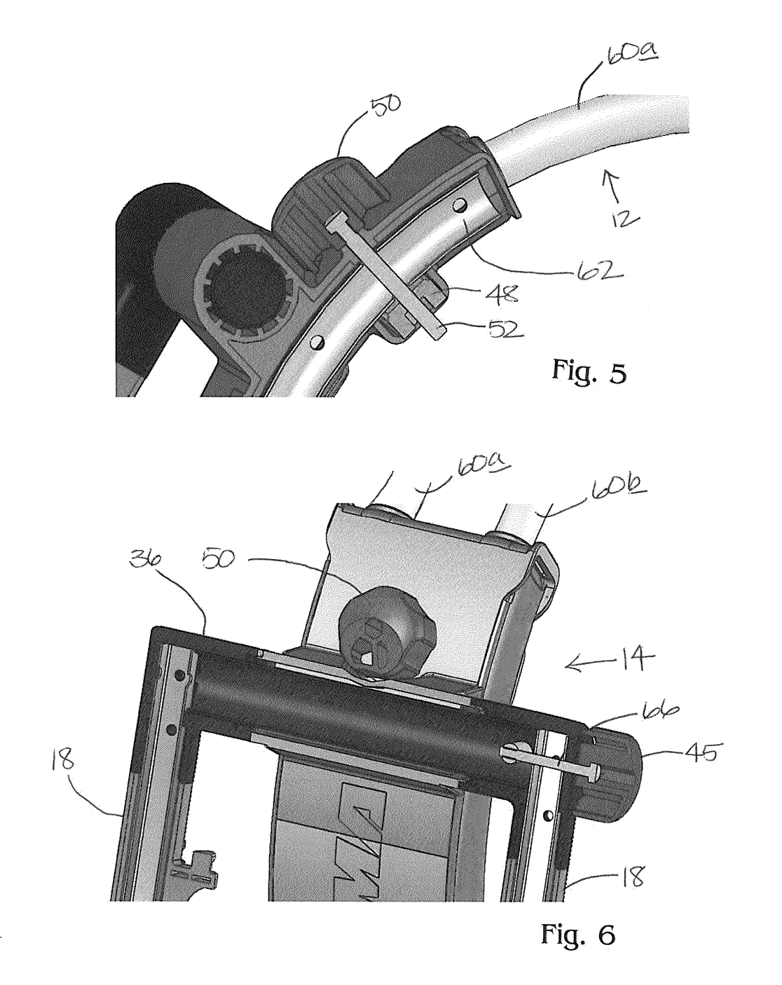

FIG. 5 shows a cross-sectional view through slide restriction mechanism 46 of rack 10. First frame element 12 has a pair of arcuate parallel bars 60a, 60b engaging second frame element 14, as previously described and shown in FIG. 4. Second frame element 14 has central arcuate tube member 62. Bolt 52 passes through second frame element 14, specifically through tube member 62 in a direction perpendicular to a tangent of tube member 62. Knob 50 is connected to bolt 52 such that rotation of knob 50 causes bolt 52 to rotate and effectively tighten or pull clamping member 48 into a clamping position with respect to bars 60a, 60b of first frame element 12.

FIG. 6 shows a cross-section through the locking device for permitting selective adjustment of position of arms 18 relative to first and second frame elements 12, 14. Generally, adjustment of arms 18 relative to first and second frame elements 12, 14 is performed after relative adjustment of the first and second frame elements has been completed and fixed relative to a specific vehicle trunk or hatch configuration. Knob 45 is connected to bolt 66 and is operable for allowing manipulation, i.e., rotation of bolt 66 to achieve tightening or loosening of shoulder 20, as previously described.

As an alternative to the described tightening systems (for both the arm fixation and slide restriction mechanisms), the movable elements could be fixed in place using a mechanism that assigns discrete relative positions to the elements, such as a pawl and ratchet system. Other tightening systems are possible that would allow, alternatively, free adjustability and substantial fixation of the frame elements. For example, the mechanism could use an over-center latch coupled to a tightening element.

Having described the operative features of an embodiment of a bicycle carrier, there follows a description of a way in which it may be used. To fit a carrier to a vehicle, a user may initially place one or more of feet 16 of the first and second frame elements 12, 14 against the vehicle; this may involve resting foot 16 of the element against a trunk or back surface of the vehicle. The user may then ensure that the slide restriction mechanism 46 of the carrier is loosened sufficiently to allow relatively free sliding movement between the first and second frame element bodies 22, 24. Alternatively, the user may perform this step before placing the frame element against the vehicle.

The user may next determine the correct relative position for the “free” frame element (the one whose associated foot is not yet positioned against the vehicle). To do this, the user may slide the body of the free frame element relative to the body of the first frame element until the foot coupled to the free frame element contacts or is otherwise coupled to the vehicle. For example, assume for the moment that the user initially placed the foot of the second frame element 14 against the vehicle. The user could relatively easily hold that frame element in place while simultaneously sliding the first frame element 12 relative to the second frame element 14 (e.g. while the user slides the first frame element body 22 out of the tubular portion of the second frame element body 24). In embodiments where the frame elements and/or the element bodies are arcuate and tubular, the user may slide the second frame element body 24 along an arcuate path until the first frame element 12 (or an associated foot 16) contacts the vehicle in a desired location. This type of adjustment can be described as a “telescoping” adjustment mechanism.

In essence, the user adjusts the described bicycle carrier by sliding the frame elements 12, 14 relative to each other until the appropriately-sized semicircular structure for a given vehicle is formed. Upon configuring the bicycle carrier with the appropriately-sized frame for mounting to a given vehicle location, the user can fix the carrier to the desired size by tightening the slide restriction mechanism 46 or other fixation mechanism to prevent further sliding of the legs relative to each other.

For more secure fixation to a vehicle, the user may couple the carrier to various portions of the vehicle through the use of straps 15. In some situations, the user may first configure the carrier and then affix the straps to the vehicle. In other situations, however, the user may attach the straps to the vehicle before final configuration of the frame elements is performed (i.e. when the frame is “roughly” the right size), only fixing the final relative position of the frame elements after the straps have been put into place.

Finally, the user may position the arms 18 of the carrier to the correct angular position for carrying one or more bicycles on the vehicle. Of course, though shown as an embodiment of a bicycle carrier, the described adjustable frame elements could be used with arms configured to carry other types of sporting goods, work tools, or accessories, as a user may desire. The arms may also be equipped with different combinations of saddles and stabilizers for carrying bikes. The user may release the arm fixation mechanism 44 so that relatively free movement between an arm 18 and its associated shoulder 20 is achieved. The user may then position the arm at a desired position relative to the carrier and vehicle so that a given bicycle (or other article) can be supported stably. The user may then tighten the arm fixation mechanism so that the arm and shoulder are substantially fixed in a given configuration. For most effective fixation, the user may position the arm and shoulder so that the castellated surfaces mesh together (with peaks being snugly held in valleys).

The user may note, for future mounting to the same or a similar vehicle, the relative position of the frame elements by reference to where one frame element sits relative to the measurement marks on the other. For use on a first vehicle, this could be measurement mark “A,” while for use on a second vehicle, this could be measurement mark “B.” Once the user removes the carrier from a vehicle after use, the user may release the slide restriction mechanism to collapse the carrier for storage (e.g. the user may fully telescope one frame element into the other). When the carrier is next required to be used on a given vehicle for which a measurement mark is known, the user may arrange the frame elements to an appropriate configuration before mounting the carrier to the vehicle. To do this, the user may simply move (i.e. slide) the frame elements until a reference point on the first frame element is located at the measurement mark of the second frame element that gives an appropriately-sized carrier for that given vehicle. The user may then tighten the slide restriction mechanism and mount the preconfigured carrier to the vehicle.

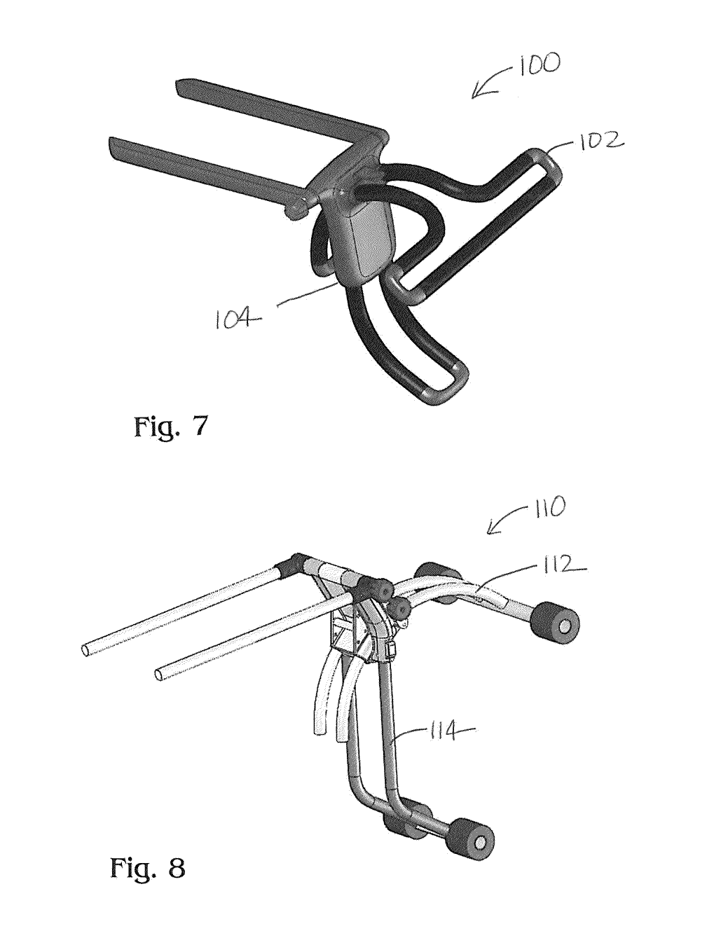

FIG. 7 shows rack 100 for carrying cargo on the rear of a vehicle. Rack 100 includes first and second frame elements 102, 104 which have arcuate tube portions, however, configured different from the frame elements previously described. First frame element 102 has a continuous key-shaped loop at one end for interfacing against a vehicle surface. The other end of first frame element 102 extends through a body portion of second frame element 104 for providing accommodation to a particular vehicle configuration. It may be assumed that the clamp devices used in rack 100 are similar to those previously described.

As shown in FIG. 8, rack 110 also uses an arcuate-shaped first frame element 112 which is slidable relative to second frame element 114. It may be assumed that the clamp devices used in rack 110 are similar to those previously described.

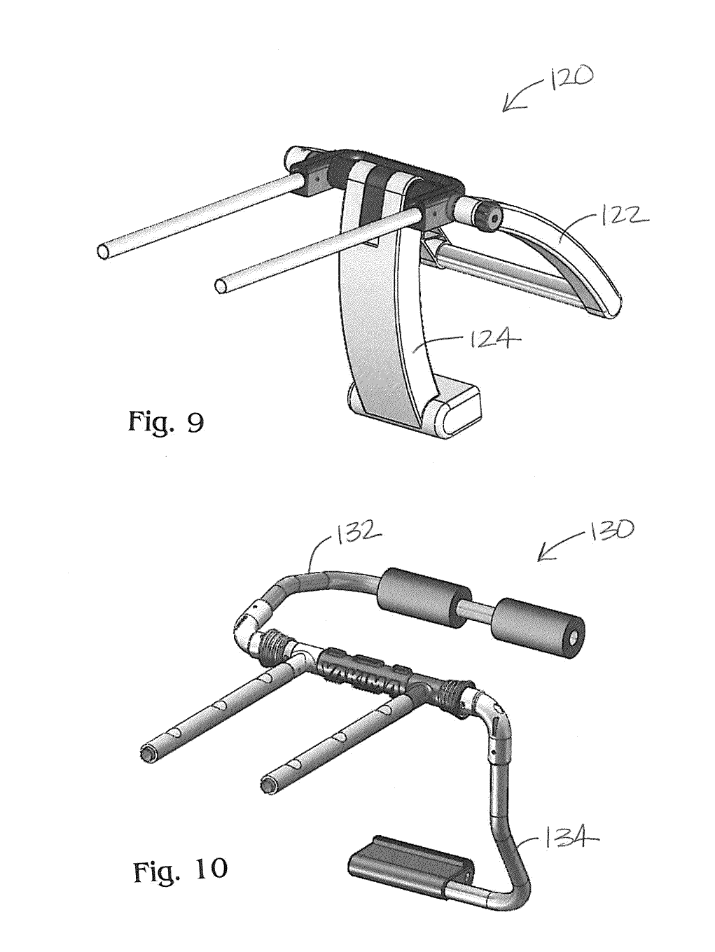

FIG. 9 shows another rack embodiment 120 including first frame element 122 coupled to second frame element 124. First frame element 122 and second frame element 124 are pivotally coupled to each other instead of using a sliding engagement mechanism for adjustment purposes. It may be assumed that the clamp devices used in rack 120 are similar to the clamp device previously described with respect to the shoulder of rack 10 in FIGS. 1-6.

FIG. 10 shows another rack configuration 130 which, similar to rack 120, uses a pivoting adjustment mechanism between first frame element 132 and second frame element 134 provide adjustment for accommodating different vehicle configurations, instead of a sliding engagement mechanism as previously described.

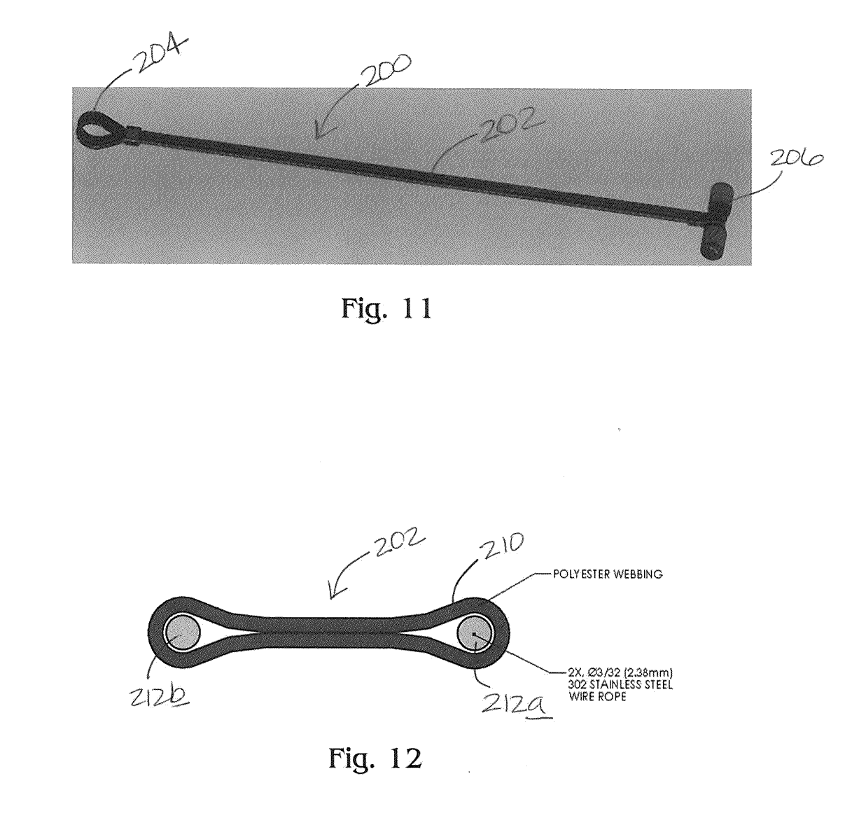

FIG. 11 shows cut-resistant security strap for tethering a rack or cargo item, such as a bicycle, to a vehicle. Strap 200 includes strap member 202 having looped end 204 and enlarged or toggled end 206. Toggled end 206 has an enlarged semi-rigid configuration that can be positioned inside a vehicle compartment with the strap passing through a crack or gap between, for example, a door and main vehicle body, and is large enough so it cannot be pulled through the gap.

FIG. 12 shows a cross-section through strap portion 202. Strap portion 202 includes polyester webbing 210 with embedded stainless steel wire rope strands 212a, 212b for resisting cutting.

FIG. 13 shows strap 200 looped around rack 220. Toggled end 206 is threaded through loop 204. Toggled end 206 is then placed inside a compartment of the vehicle, for example, the trunk or passenger compartment, before closing the trunk, hatch, or door. The trunk, hatch or door is then closed and locked, preventing the toggled end of security strap 200 from being removed from the vehicle.

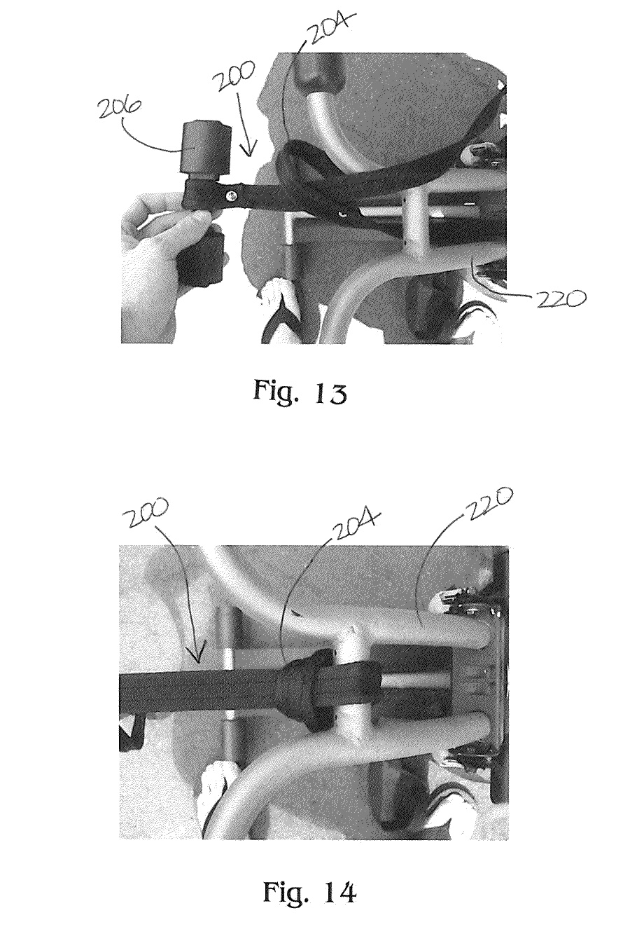

FIG. 14 shows looped end 204 tensioned or tightened around rack 220.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variance.

We claim:

1. A carrier for a bicycle, comprising:
a first frame element configured to couple to a vehicle;
a second frame element having a body configured to couple to a vehicle and to allow the first frame element to slide within the body; and
a slide restriction mechanism configured to inhibit reversibly the sliding of the first frame element within the body of the second frame element.

2. The carrier of claim 1 further comprising measurement marks on at least one of the first frame element or the second frame element, wherein the measurement marks are configured to measure a sliding motion of the first frame element relative to the second frame element.

3. The carrier of claim 1, wherein the slide restriction mechanism includes a clamping member and a tightening mechanism, wherein the tightening mechanism actuates the clamping mechanism to press against at least a portion of the first frame element or the second frame element.

4. The carrier of claim 1 further comprising:
a shoulder component mounted to at least one of the first frame element and the second frame element; and
at least one arm coupled to the shoulder such that the at least one arm is reversibly angularly movable relative to the frame element to which the shoulder is mounted.

5. The carrier of claim 4, wherein the shoulder component and the at least one arm have castellated surfaces configured to restrict motions of the arm to discrete increments of angular rotation.

6. The carrier of claim 4, wherein the at least one arm includes anti-sway elements.

7. The carrier of claim 1, wherein the first frame element comprises a pair of substantially parallel tubular members having a roughly circular cross-section, and wherein the second frame element comprises a pair of substantially parallel tubular members having a roughly square cross-section.

8. A method for mounting a bicycle carrier to a vehicle, comprising:
placing a first frame element and a second frame element of the carrier in a preliminary configuration relative to the vehicle;
slidingly translating the first frame element or the second frame element relative to the other frame element to place the carrier in a configuration approximating a final configuration; and
fixing the carrier in the final configuration.

9. The method of claim 8, wherein the step of slidingly translating includes monitoring the extent of sliding with reference to measurement marks on at least one of the first frame element or the second frame element.

10. The method of claim 8, wherein the step of fixing the final configuration of the carrier includes fixing the configuration with a clamping member and a tightening mechanism, wherein the tightening mechanism actuates the clamping mechanism to press against at least a portion of the first frame element or the second frame element

11. The method of claim 8 further comprising the step of rotating a shoulder component relative to at least one of the first and second frame elements to provide an angular position for an arm coupled to the shoulder.

12. The method of claim 11, wherein the shoulder component and the arm include interacting castellated surfaces configured to restrict motions of the arm to discrete increments of angular rotation relative to the shoulder, and wherein the step of rotating includes selecting and fixing a preferred angular position for the arm.

13. A carrier for a bicycle, comprising:
a first arcuate frame element;
a second arcuate frame element configured to allow longitudinal sliding of the first frame element through at least portion of the second frame element; and
a slide restriction mechanism configured to inhibit reversibly the sliding of the first frame element through the second frame element

14. The carrier of claim 13 further comprising measurement marks on at least one of the first frame element or the second frame element, wherein the measurement marks are configured to measure a sliding motion of the first frame element relative to the second frame element.

15. The carrier of claim 13, wherein the slide restriction mechanism includes a clamping member and a tightening mechanism, wherein the tightening mechanism actuates the clamping mechanism to press against at least a portion of the first frame element or the second frame element.

16. The carrier of claim 13 further comprising:
a shoulder component mounted to at least one of the first frame element and the second frame element; and
at least one arm coupled to the shoulder such that the at least one arm is reversibly angularly movable relative to the frame element to which the shoulder is mounted.

17. The carrier of claim 16, wherein the shoulder component and the at least one arm have castellated interaction surfaces configured to restrict motions of the arm to discrete increments of angular rotation.

18. The carrier of claim 16, wherein the at least one arm includes anti-sway elements.

19. The carrier of claim 13, wherein the first frame element comprises a pair of substantially parallel tubular members having a roughly circular cross-section, and wherein the second frame element comprises a pair of substantially parallel tubular members having a roughly square cross-section.

20. The carrier of claim 19, wherein the first frame element slides within the cross-sectional area of the second frame element.
